(19) United States
(12) Patent Application Publication
(10) Pub. No.: US 2012/0141076 A1
(43) Pub. Date: Jun. 7, 2012

(54) OPTICAL CONNECTOR ASSEMBLED WITH RETAINING SHELL

(75) Inventor: YU ZHU, Shenzhen (CN)

(73) Assignee: HON HAI PRECISION INDUSTRY CO., LTD., New Taipei (TW)

(21) Appl. No.: 13/213,094

(22) Filed: Aug. 19, 2011

(30) Foreign Application Priority Data
Dec. 7, 2010 (CN) 201020644134.4

(51) Int. Cl. G02B 6/36

(52) U.S. Cl. 385/92

(57) ABSTRACT

An optical connector for mounting to a circuit board includes an insulative housing, an optical element housed in the housing and a retaining shell assembled to the housing. The housing includes a mounting face and a receiving cavity depressed from the mounting face. The optical element is housed into the receiving cavity through the mounting face. The retaining shell is assembled to the mounting face and forms a holding portion resiliently pressed against the optical element. The holding portion is sandwiched between the mounting face and the circuit board.

### BACKGROUND OF THE INVENTION

1. Field of the Invention

The present invention relates to an optical connector, and more particularly to an optical connector assembled with a retaining shell.

2. Description of Related Art

In recent years, the digital signal transmission technologies using optical communications have been used in a variety of household apparatuses. Such household apparatus usually has an optical connector with a photoelectric converter (optical element) embedded therein and the converter will generate heat during the photoelectric convert process.

U.S. Pat. No. 4,778,240 issued to Komatsu on Oct. 18, 1988 discloses such an optical connector. The connector comprises a cylindrical hole for receiving a complement plug and a box-shaped portion on rear part of the cylindrical hole with a bottom opening After receiving an optical element there through, the bottom opening is sealed by mounting to a circuit board, which leads to a poor thermal elimination.

Hence, an improved optical connector is required to overcome the disadvantages of the related art.

### SUMMARY OF THE INVENTION

Accordingly, an object of the present invention is to provide an optical connector, and more particularly to an optical connector assembled with a retaining shell for holding an optical element within the connector.

In order to achieve the above-mentioned object, an optical connector for mounting to a circuit board, comprises an insulative housing, an optical element housed in the housing and a retaining shell assembled to the housing. The housing comprises a mounting face and a receiving cavity depressed from the mounting face. The optical element houses into the receiving cavity through the mounting face. The retaining shell is assembled to the mounting face and forms a holding portion resiliently pressed against the optical element. The holding portion is sandwiched between the mounting face and the circuit board.

Other objects, advantages and novel features of the present invention will become more apparent from the following detailed description of the present embodiment when taken in conjunction with the accompanying drawings.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an optical connector according to the present invention;

FIG. 2 is another perspective view of the optical connector;

FIG. 3 is an exploded, perspective view of the optical connector of FIG. 2.

FIG. 4 is a cross-sectional view taken along a line 4-4 shown in FIG. 1.

### DETAILED DESCRIPTION OF THE INVENTION

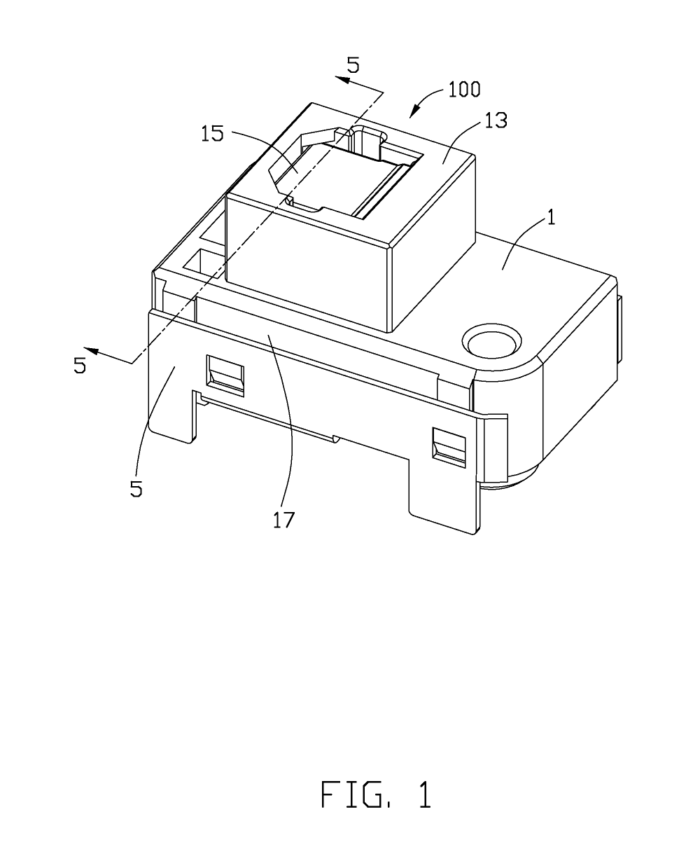

Referring to FIGS. 1 to 4, an optical connector 100 adapted for mounting on a printed circuit board (not shown) according to an embodiment of the present invention is shown to include an insulating housing 1, an optical element 3 received in the housing and a retaining shell 5 for holding the optical element 3 within the housing 1. The insulative housing 1 comprises a mounting face 11, a mating face 13 parallel to the mounting face 11 and a guiding hole 131 passing through the mating face and the mounting face. An out-swinging shutter 15 is assembled to the mating face so as to close the guiding hole 131 when an optical fiber cable is not used.

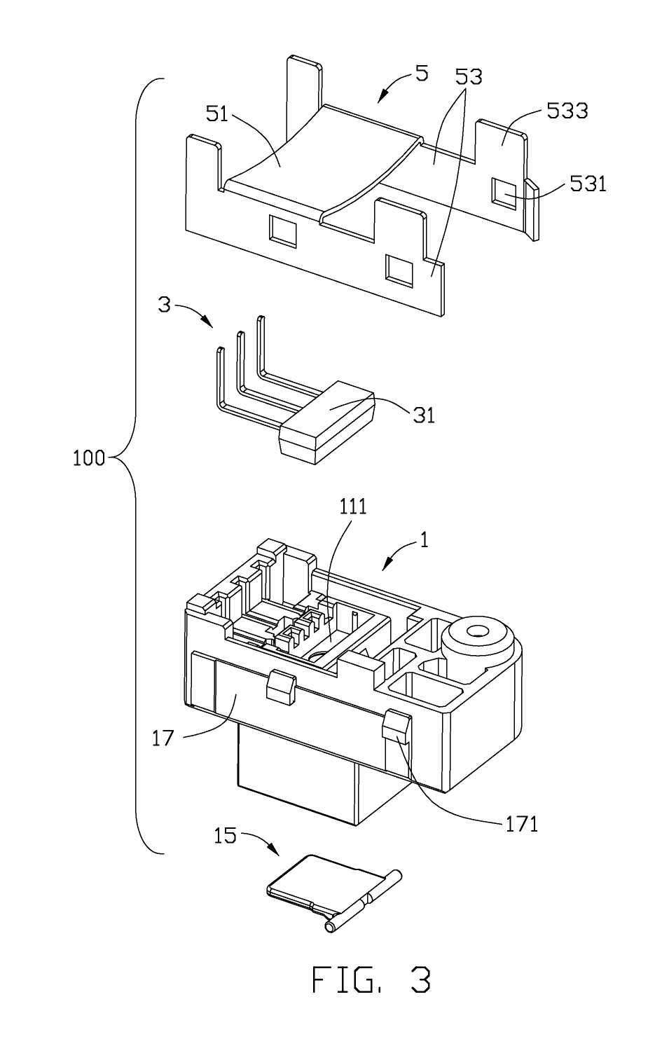

Referring to FIG. 3, the insulative housing 1 comprises a receiving cavity 111 depressed from the mounting face 11 for housing the optical element 3 and a pair of sidewalls 17 perpendicularly to the mounting face 11. The retaining shell 5 defines a holding portion 51 substantially parallel to the mounting face for resiliently pressing against the optical element 3 and a pair of side arms 53 perpendicularly bending from opposite ends of the holding portion 51 for fixing on the sidewalls 17 of the housing. Each side arm forms two soldering pads or legs 533 extending away from the lower side of the mounting face 11 adjacent two sides of the holding portion. Two wedge portions 171 are formed on each sidewall 17 with angled surfaces toward the mounting face 11 side for latching with punched holes 531 formed on the side arms.

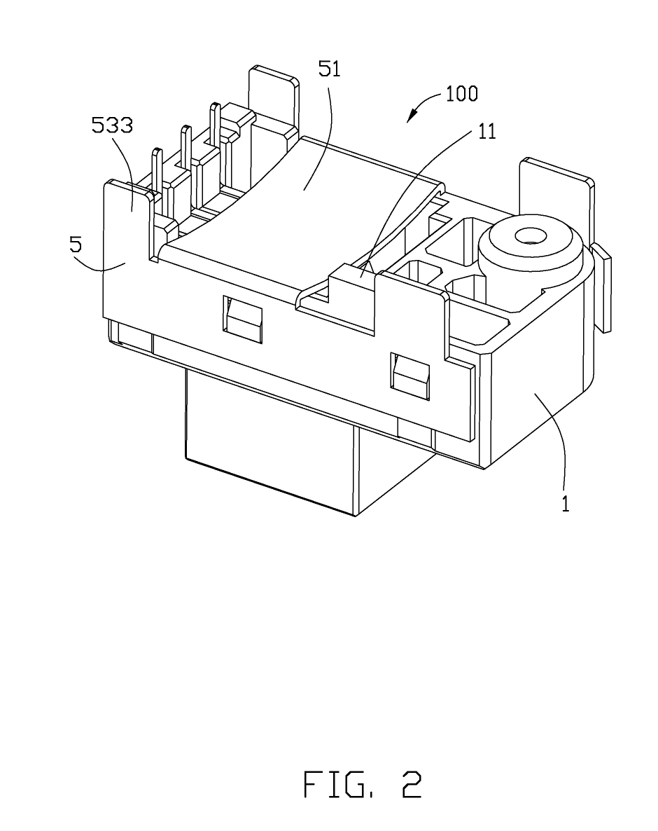

Referring to FIGS. 2 to 4, after the optical element 3 housed into the receiving cavity 111 through the mounting face 11 along an insert direction perpendicularly to the mounting face, the retaining shell 5 is assembled onto and lock with the housing along the insert direction. The optical element 3 comprises a photoelectrical-converting portion with a convert surface (not labeled), a rear surface 31 opposite to the convert surface and three legs (not labeled) exposing to the mounting face of the insulating housing. The holding portion 51 is resiliently pressed against the rear surface 31 of the optical element 3. The holding portion 51 is an arc-shaped metal plate and forms a generally upside-down M-shape with the two side arms 53. The holding portion 51 is sandwiched between the mounting face 11 and the circuit board after total installation.

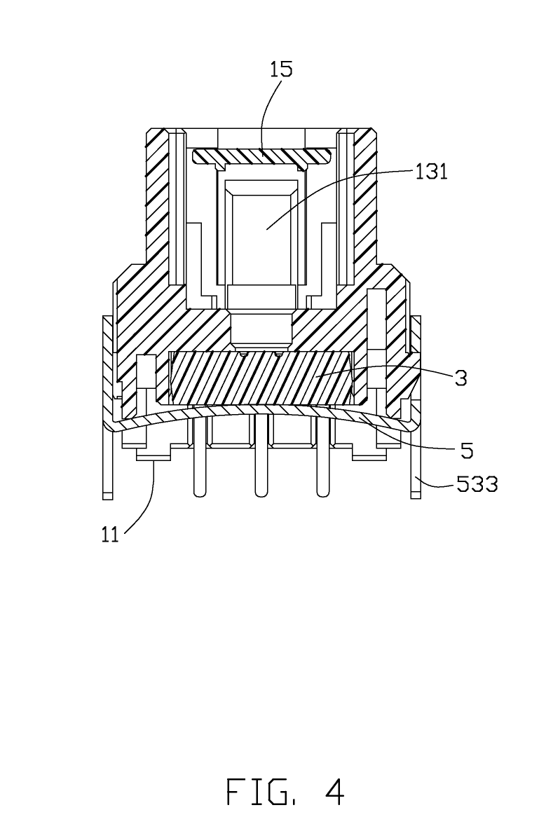

Referring to FIG. 4, the retaining shell 5 which presses against the optical element 3 and fits on the circuit board can easily hold the optical element and optimize heat elimination. And the holding portion located under the housing also leads to a compact structure. What's more, because of the M-shape of the retaining shell and the arc-shaped holding portion, the two side arms and the housing can lock tightly.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An optical connector for mounting to a circuit board, comprising:
an insulative housing defining a mounting face confronting with the circuit board and a receiving cavity depressed from the mounting face; and
an optical element housed into the receiving cavity through the mounting face;
wherein a retaining shell is assembled to the insulative housing and defines a holding portion resiliently pressed against the optical element from the mounting face, so the holding portion is sandwiched between the mounting face and the circuit board.

2. The optical connector as described in claim 1, wherein the holding portion is made from a metal sheet and widely-arc bends toward the optical element.

3. The optical connector as described in claim 2, wherein the holding portion projects away from the mounting face.

4. The optical connector as described in claim 1, wherein the optical element comprises a photoelectrical-converting portion with a convert surface and a rear surface opposite to the convert surface, the holding portion is resiliently pressed against the rear surface of the optical element.

5. The optical connector as described in claim 1, wherein a pair of side arms substantially bends from opposite ends of the holding portion to fix on the insulative housing and each side arm defines at least one soldering pad extending away from the mounting face.

6. The optical connector as described in claim 5, wherein the holding portion is an arc-shaped metal plate and the two side arms and the holding portion has a generally upside-down M-shape.

7. The optical connector as described in claim 6, wherein the insulative housing defines a mating face parallel to the mounting face and a guiding hole is passing through the mating face and the receiving cavity.

8. The optical connector as described in claim 5, wherein wedge portions are formed on the sidewalls with angled surfaces toward the mounting face side for latching with punched holes formed on the side arms.

9. An optical connector comprising:
an insulative housing defining a mating cavity through a first outface thereof for receiving a counter connector and a receiving cavity through a second outface thereof;
an optical element housed into the receiving cavity through the second side face, the optical element defining a smooth face exposing to and parallel to the second outface; and
a retaining shell locked with the insulative housing and defining a smoothly and widely arc-curve holding portion resiliently pressed against the smooth face of the optical element.

10. The optical connector as described in claim 9, wherein a pair of side arms bends from opposite ends of the holding portion along an arc curve to lock with outer faces different from said first and second outfaces of the housing.

11. The optical connector as described in claim 10, wherein the holding portion is an arc-shaped metal plate, the two side arms and the holding portion have a generally upside-down M-shape.

12. The optical connector as described in claim 11, wherein each side arm defines at least one soldering pad extending away from the mounting face.

13. The optical connector as described in claim 12, wherein the optical element comprises legs exposing to the second outface of the insulating housing.

14. An optical connector assembly for mounting to a printed circuit board, comprising:
a housing defining first and second exterior faces for mating and mounting respectively;
a mating cavity formed in the housing behind the first exterior face;
a receiving cavity formed in the housing behind the second exterior face;
an optical element received in the receiving cavity with corresponding legs extending outwardly beyond the second exterior face for mounting to the printed circuit board; and
a metallic shell attached to the housing on the second exterior face; wherein
said shell defines a plurality of soldering legs extending outwardly beyond the second exterior face for mounting to the printed circuit board, and a resilient section abuts against the optical element toward the first exterior face and is located at a level not beyond the second exterior face for assuring forces applied to the optical element from the resilient section of the shell is not affected by the printed circuit board.

15. The optical connector assembly as claimed in claim 14, wherein said first exterior face and said second exterior face are opposite and parallel each other.

16. The optical connector assembly as claimed in claim 14, wherein the legs of the optical element defines a right angle.

17. The optical connector assembly as claimed in claim 14, wherein the mating cavity is protectively hidden behind a pivotal door.

18. The optical connector assembly as claimed in claim 17, wherein a pivot of the pivotal door is located on one side of the pivotal door in a first direction, while legs of the optical element are located on another side of the optical element in a second direction opposite to the first direction.
